(19) United States
(12) Patent Application Publication
(10) Pub. No.: US 2018/0065000 A1
(43) Pub. Date: Mar. 8, 2018

(54) METHOD FOR MAKING A PIECE UNIT OF LINERS OF AMERICAN FOOTBALL

(71) Applicant: LIANG-FA HU, TAICHUNG (TW)

(72) Inventor: LIANG-FA HU, TAICHUNG (TW)

(21) Appl. No.: 15/257,931

(22) Filed: Sep. 7, 2016

(51) Int. Cl. A63B 41/00; B29C 65/48; B29C 65/70; B29C 65/02

(52) U.S. Cl. CPC A63B 41/00; B29C 65/48; B29L 2031/545; B29C 65/02; B29C 65/70

(57) ABSTRACT

A method for making a piece unit of liners of American football comprises an adhering step, a cutting step, and a curing step. An extrusion-molded thermoplastic elastomer (TPE) is hot compressed molding material with a backing fabric to form a pseudo-adhesive semi-finished molding material. The semi-finished molding material is cut to be a piece unit and remain a surplus material. The piece unit is cured to form a flat piece material or a curved piece material. It may shorten the process and control the parameters and changes (such like foaming coefficient, colors, and etc.) easily. Furthermore, the strength of the ball cover may become stronger because each flat piece material or curved piece material has the arrangement of the backing fabric.

### FIELD OF THE INVENTION

The present invention relates to a method for making a ball, and more particularly to a method for making a piece unit of liners of American football.

### BACKGROUND OF THE INVENTION

The conventional method for making the liners of the American football may refer to US patent 2004/0229721. It is made by compressing and vulcanization a rubber piece with at least a fabric lining, is strong enough to produce a more durable American football with better supporting but lower manufacturing cost. The American football includes a ball cover having a valve hole thereon and an inflatable bladder disposed within the ball cover for propping up the ball cover after inflation. The inflatable bladder has a predetermined shape and a valve stem mounted thereon and extended through the valve hole of the ball cover. The ball cover includes four elliptical cover pieces sewn edge to edge together. Each of the cover pieces includes an outer elliptical cover skin and an inner elliptical construction liner which is overlappedly attached on an inside of the cover skin for supporting the cover skin and enclosing the inflatable bladder.

However, the materials of rubber are complicated and the formula has 10˜20 combinations to result in complicated process. The process parameters and changes (such like foaming coefficient, colors, and etc.) are hard to control to result in increasing the cost. Furthermore, the surplus material after cutting is not able to be recycled. It is not environment friendly.

In view of the foregoing circumstances, the inventor has invested a lot of time to study the relevant knowledge, compare the pros and cons, research and develop related products. After quite many experiments and tests, the “t method for making a piece unit the American football” of this invention is eventually launched to improve the foregoing shortcomings, to meet the public use.

### SUMMARY OF THE INVENTION

An objective of this invention is providing a method for making a piece unit of liners of American football. It may shorten the process and control the parameters and changes (such like foaming coefficient, colors, and etc.) easily. Furthermore, the strength of the ball cover may become stronger because each flat piece material or curved piece material has the arrangement of the backing fabric.

To achieve above objectives, a method for making a piece unit of liners of American football is disclosed. The method comprises:

an adhering step: hot compressing an extrusion-molded thermoplastic elastomer (TPE) molding material with a backing fabric to form a pseudo-adhesive semi-finished molding material;

a cutting step: cutting the semi-finished molding material to be a piece unit and remain a surplus material; and

a curing step: curing the piece unit to form a flat piece material or a curved piece material.

In some embodiments, the above mentioned method may further comprise a recycling step, the TPE molding material of the surplus material is peeled from the backing fabric of the surplus material and then the TPE molding material of the surplus material is recycled to put into a tank so as to extrusion mold another TPE molding material.

A plurality of the flat piece materials or the curved piece materials may be sewed by hand or machine or adhered on an outer surface of a ball-shaped bladder to form a ball cover so as to cover the ball-shaped bladder.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is a process schematic of a method for making a piece unit of liners of American football of the present invention.

FIG. 2 is a perspective view of a flat piece material of the method for making a piece unit of liners of American football of the present invention.

FIG. 3 is a perspective view of a curved piece material of the method for making a piece unit of liners of American football of the present invention.

FIG. 4 is a perspective view of a ball cover of the present invention.

FIG. 5 is a flow chart of the method for making a piece unit of liners of American football of the present invention.

### DESCRIPTION OF THE PREFERRED EMBODIMENT

Referring now to the drawings where like characteristics and features among the various figures are denoted by like reference characters.

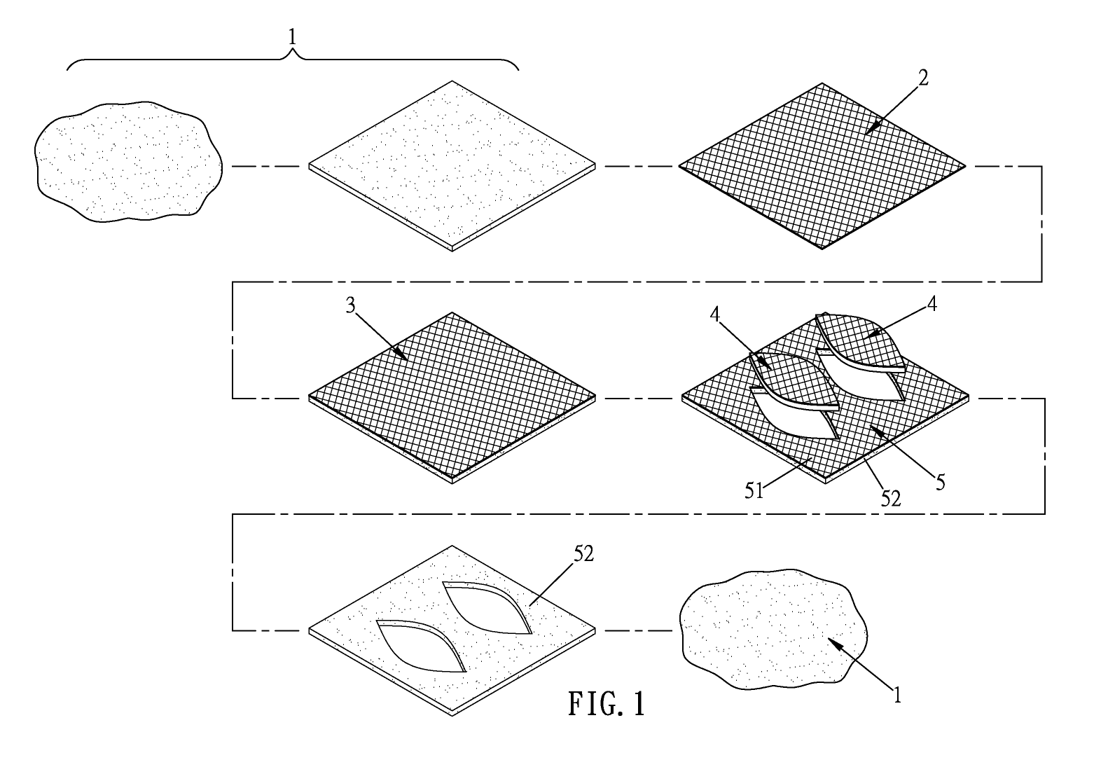

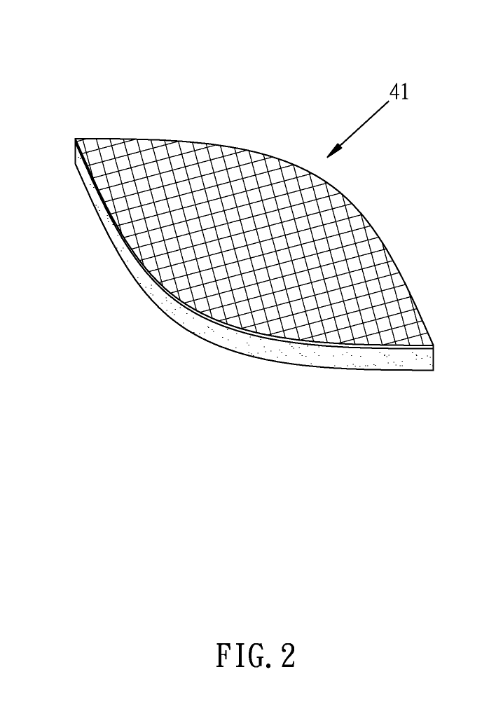

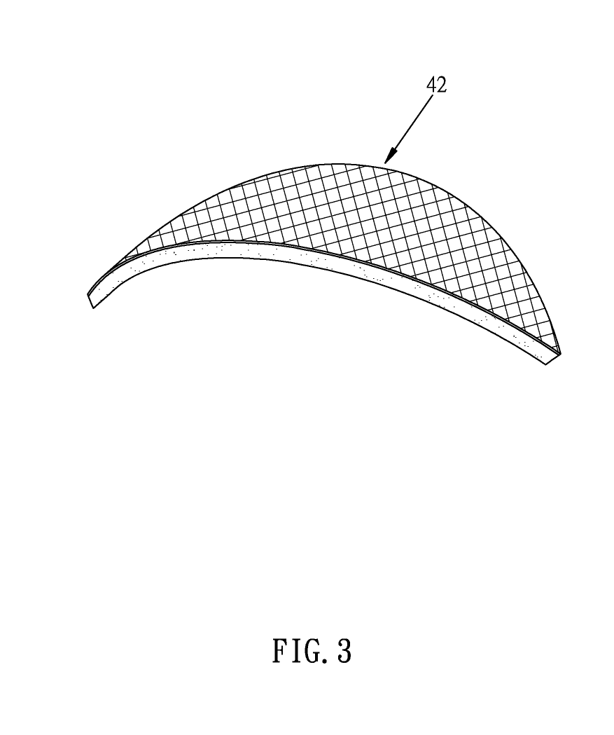

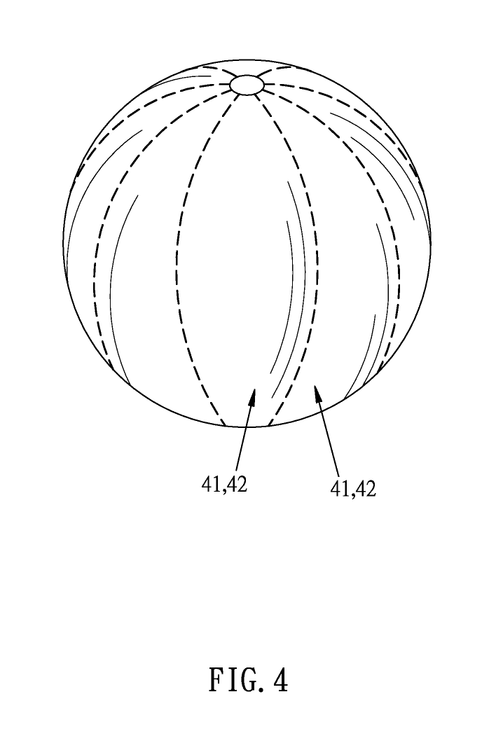

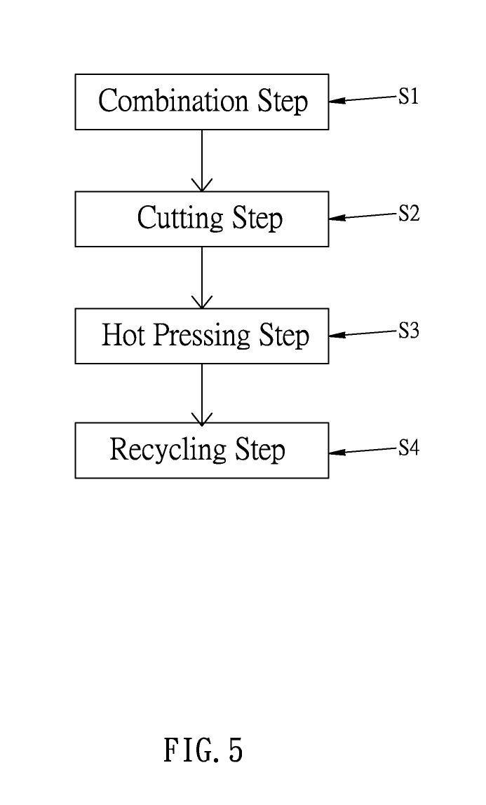

Please refer to FIGS. 1 to 5, a method for making a piece unit of liners of American football of the present invention may comprise:

an adhering step S1: hot compressing an extrusion-molded thermoplastic elastomer (TPE) molding material 1 with a backing fabric 2 to form a pseudo-adhesive semi-finished molding material 3;

a cutting step S2: cutting the semi-finished molding material 3 to be a piece unit 4 and remain a surplus material 5; and

a curing step S3: curing the piece unit 4 to form a flat piece material 41 or a curved piece material 42.

The above mentioned method may further comprise a recycling step S4 The TPE molding material 51 of the surplus material 5 is peeled from the backing fabric 52 of the surplus material 5 and then the TPE molding material 51 of the surplus material 5 is recycled to put into a tank (not shown) so as to extrusion mold another TPE molding material 1. Therefore, it may achieve the effects of saving materials, environmental protection, and reducing the cost.

According to above mentioned method, compared to the prior art, it may shorten the process and control the parameters and changes (such like foaming coefficient, colors, and etc.) easily.

In addition, a plurality of the flat piece materials 41 or the curved piece materials 42 may be sewed by hand or machine or adhered on an outer surface of a ball-shaped bladder (not shown) to form a ball cover 100 so as to cover the ball-shaped bladder. Therefore, the strength of the ball cover 100 may become stronger because each flat piece material 41 or curved piece material 42 has the arrangement of the backing fabric 2.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. A method for making a piece unit of liners of American football, the steps comprising:
an adhering step: hot compressing an extrusion-molded thermoplastic elastomer (TPE) molding material with a backing fabric to form a pseudo-adhesive semi-finished molding material;
a cutting step: cutting the semi-finished molding material to be a piece unit and remain a surplus material; and
a curing step: curing the piece unit to form a flat piece material or a curved piece material.

2. The method as claimed in claim 1, further comprising a recycling step, the TPE molding material of the surplus material is peeled from the backing fabric of the surplus material and then the TPE molding material of the surplus material is recycled to put into a tank so as to extrusion mold another TPE molding material.

3. The method as claimed in claim 1, wherein a plurality of the flat piece materials or the curved piece materials may be sewed by hand or machine or adhered on an outer surface of a ball-shaped bladder to form a ball cover so as to cover the ball-shaped bladder.
